(19) United States
(12) Patent Application Publication
(10) Pub. No.: US 2015/0360867 A1
(43) Pub. Date: Dec. 17, 2015

(54) Barbed Pick for Handling Firewood

(71) Applicant: Lee Roy William King, Bark River, MI (US)

(72) Inventor: Lee Roy William King, Bark River, MI (US)

(21) Appl. No.: 14/739,729

(22) Filed: Jun. 15, 2015

Related U.S. Application Data
(60) Provisional application No. 62/012,866, filed on Jun. 16, 2014.

(51) Int. Cl. B65G 7/12

(52) U.S. Cl. CPC B65G 7/12

(57) ABSTRACT

An apparatus for handling firewood contains a head and a handle. The head includes a structural body, a pointed portion, and a barb. When the user swings the apparatus by grasping the handle, a tip of the pointed portion traverses into the piece of firewood. When the pointed potion is secure with the piece of firewood, the barb prevents the apparatus from coming loose from the piece of firewood. The handle contains multiple gripping positions which can be used to carry, drag or move the piece of firewood. In particular, a lifting grip portion is used for heavy firewood and a swinging grip portion is used for swinging the device. Additionally, a grip protrusion can also be used for handling purposes.

The current application claims a priority to the U.S. Provisional Patent application Ser. No. 62/012,866 filed on June 16, 2014.

### FIELD OF THE INVENTION

The present invention relates generally to equipment used for handling firewood. More specifically, the present invention is utilized to drag and move different sized firewood. In order to do, the present invention establishes a secure connection with the piece of firewood.

### BACKGROUND OF THE INVENTION

Different tools are utilized for handling firewood. Cords and hooks are currently among the most widely used tools for carrying firewood. On the other hand, axes are used for chopping and also dragging firewood. Other sharpened tools such as hatchets, picks, pickaroons, and hammers with nail remover claws or wedges are also used in lifting, carrying, stacking, or otherwise moving pieces of firewood. However, none of these tools are particularly well suited for handling firewood.

A major disadvantage of the previously mentioned sharpened tools is that the tools do not adequately anchor within the firewood into which they are driven, and therefore may easily fall out upon lifting or moving. As a result, bodily harm can be caused to the user. Another disadvantage of using sharpened tools for handling firewood is the difficulty to remove the tool from the piece of firewood. Often times, additional tools and considerable effort is required to remove the sharpened tool from the piece of firewood. In certain circumstances, even multiple users are required to handle firewood. The additional effort can be disadvantageous to the user when handling a large stock of firewood. Moreover, the need to carry multiple tools can also be stressful to the user. Therefore, the need for a single device that can be used for lifting, moving, and dragging clearly exists.

The objective of the present invention is to address the aforementioned issues. In particular, the present invention introduces an apparatus which is specifically designed for handling firewood. In order to do so, the present invention utilizes a head of the tool which anchors into a log or piece of firewood and yet needs to be purposefully removed from within the log with relative ease and without the use of additional tools. The effective design of the present invention allows the user to utilize the present invention to carry, move or drag firewood of different sizes and different weights.

### BRIEF DESCRIPTION OF THE DRAWINGS

FIG. 1 is a perspective view of the first embodiment of the present invention.

FIG. 2 is a side view of the first embodiment of the present invention.

FIG. 3 is a detailed view of a head of the present invention.

FIG. 4 is an enlargement of the circled portion of FIG. 3, showing a tip of the pointed portion and a barb.

FIG. 5 is a top view showing the taper profile of the head and the pointed portion.

FIG. 6 is a perspective view of the second embodiment of the present invention.

FIG. 7 is a side view of the second embodiment of the present invention.

### DETAIL DESCRIPTIONS OF THE INVENTION

All illustrations of the drawings are for the purpose of describing selected versions of the present invention and are not intended to limit the scope of the present invention.

The present invention introduces an apparatus that can be used for moving, dragging, or carrying firewood. In order to so, the present invention is specifically designed such that a secure connection is established between the present invention and the piece of firewood. More specifically, a head 1 and different components of the head 1 are used when making the connection with the piece of firewood. The effective design of the present invention also allows a user to grasp the apparatus at different positions such that the user has a better mechanical advantage when handling firewood. The present invention uses a handle 12 to provide the user multiple gripping positions.

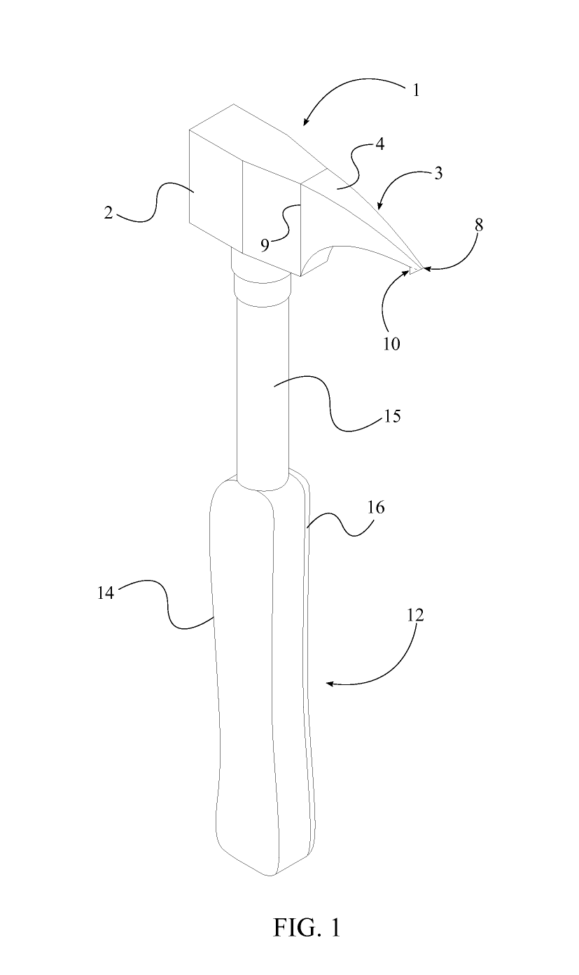

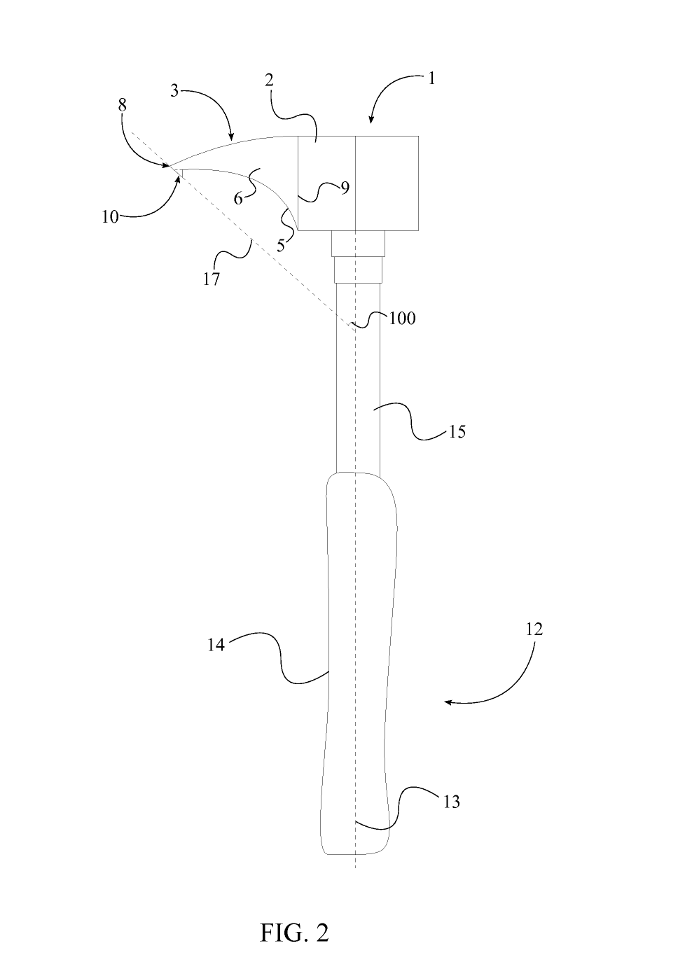

As previously described, the user controls the present invention with the handle 12. The user swings the present invention by holding onto the handle 12 such that the head 1 of the present invention establishes a connection with the piece of firewood. The head 1 and the handle 12 are illustrated in FIG. 1 and FIG. 2. As further illustrated, the head 1 comprises a structural body 2, a pointed portion 3, and a barb 10. When the head 1 makes contact with the firewood, the pointed portion 3 penetrates into the piece of firewood upon contact. The pointed portion 3 is connected adjacent to the structural body 2 and is also oriented perpendicular to the structural body 2. Therefore, the structural body 2 provides additional mass which is beneficial in driving the pointed portion 3 into the piece of firewood. As seen in FIG. 2, the handle 12 is mounted adjacent to the structural body 2 such that a majority of the force applied by the user is effectively transferred onto the pointed portion 3. When the pointed portion 3 traverses into the piece of firewood, the barb 10 ensures that the present invention remains stationary with respect to the piece of firewood. In order to do so, the barb 10 is connected adjacent to the pointed portion 3 opposite to the structural body 2. More specifically, the barb 10 is oriented towards the handle 12 such that sufficient resistance is produced between the head 1 and the piece of firewood.

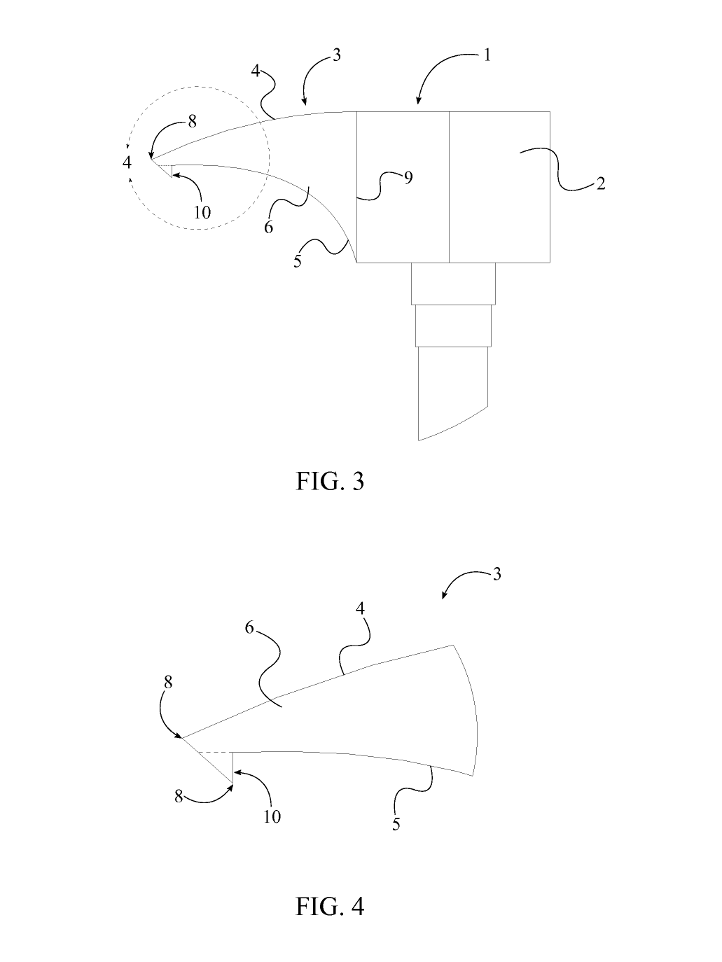

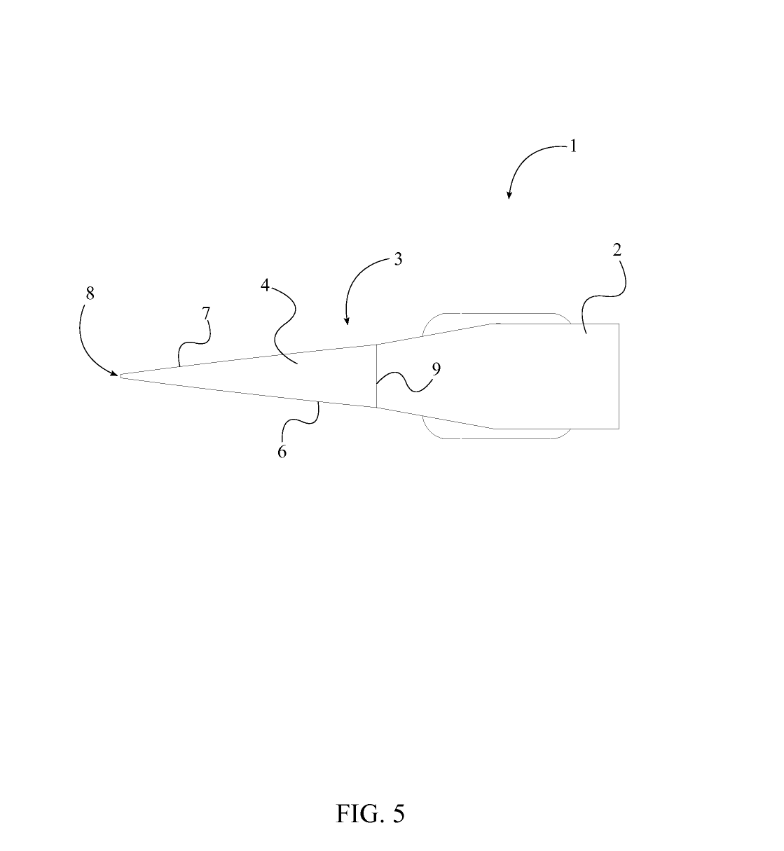

The pointed portion 3 is specifically designed to traverse into the piece of firewood with minimum effort. In order to do so, the pointed portion 3 comprises a top surface 4, a bottom surface 5, a tip 8, and a base 9 as seen in FIG. 3 and FIG. 4. The pointed portion 3 is connected to the structural body 2 at the base 9. The tip 8 which is the outermost point of the pointed portion 3, has a small surface area such that the pointed portion 3 can carve into the piece of firewood with minimum force. As seen in FIG. 5, the bigger surface area of the base 9 and the smaller surface area of the tip 8, tapers the top surface 4 and the bottom surface 5 from the base 9 to the tip 8. The top surface 4 is convexly configured with the pointed portion 3. The bottom surface 5 is concavely configured with the pointed portion 3 in order to correspond to the top surface 4. The shape of the top surface 4 and the bottom surface 5 is important to guide the pointed portion 3 into the piece of firewood. As seen in FIGS. 3-5, the pointed portion 3 further comprises a first lateral surface 6 and a second lateral surface 7. The first lateral surface 6 and the second lateral surface 7 are also appropriately shaped to create a body shape which is advantageous when penetrating into the piece of firewood. More specifically, the first lateral surface 6 and the second lateral surface 7 also taper the pointed portion 3 from the base 9 to the tip 8.

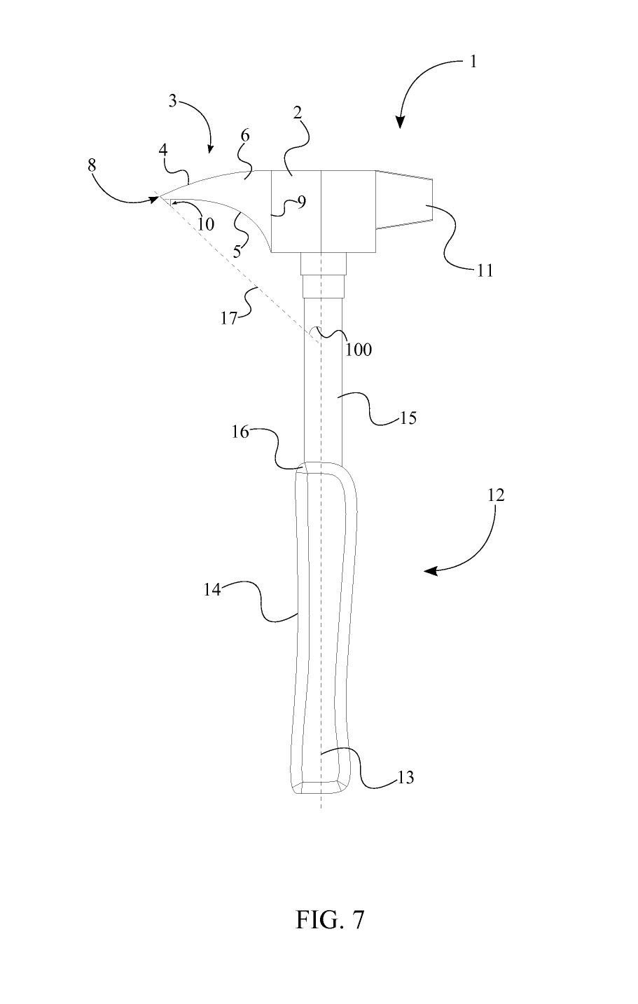

As discussed earlier, the user controls the present invention by gripping the handle 12. The handle 12 comprises a central axis 13, a swinging grip portion 14, and a lifting grip portion 15. The connection between the handle 12 and the head 1 is such that, a line 17 delineated between the tip 8 of the pointed portion 3 and a tip 8 of the barb 10 is oriented at an acute angle 100 with the central axis 13. The acute angle 100 is beneficial in securing the pointed portion 3 within the piece of firewood. The acute angle 100 is illustrated in FIG. 2 and FIG. 7. The swinging grip portion 14 and the lifting grip portion 15 are used alternatively when handling different sized firewood. As seen in FIG. 2 and FIG. 7, the lifting grip portion 15 is connected adjacent to the structural body 2. When handling heavy loads, the pulling force or the pushing force needs to be applied close to the load. Therefore, the lifting grip portion 15 is specifically used when lifting heavier loads. Even though the swinging grip portion 14 can also be used with heavier pieces of firewood, a high probability exists for the device to come loose from the piece of firewood. The swinging grip portion 14 is connected adjacent to the lifting grip portion 15 opposite to the structural body 2. Since the swinging grip portion 14 is farthest from the structural body 2 and the pointed portion 3, the user applies more force by utilizing the swinging grip portion 14 during the swinging motion. As a result, the pointed portion 3 traverses further into the piece of firewood. A rubberized coating 16 is superimposed onto the swinging grip portion 14 allowing the user to establish a firm grip with the present invention.

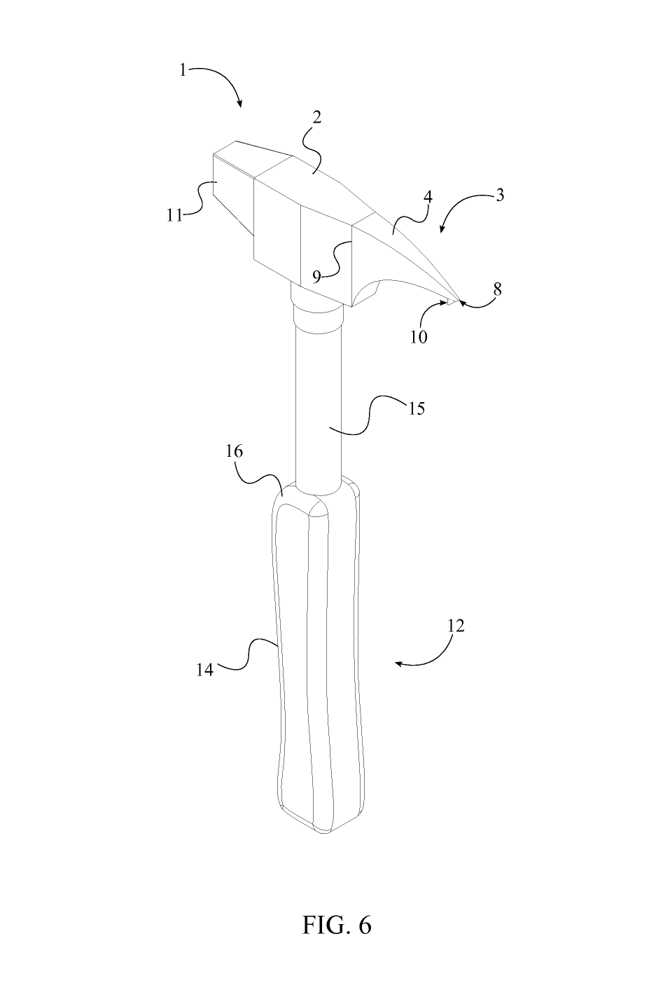

Even though the lifting grip portion 15 is sufficient for handling certain weights, extremely heavy pieces of firewood may require additional support. In order to address the issue, the head 1 comprises a grip protrusion 11 in another embodiment of the present invention. As seen in FIG. 6 and FIG. 7, the grip protrusion 11 is connected adjacent to the structural body 2 opposite to the pointed portion 3. Since the structural body 2 is the closest to the pointed portion 3, the user may need to hold the present invention at the structural body 2 when handling certain heavy pieces of firewood. Since the grip protrusion 11 extends from the structural body 2, the user is provided with additional surface area to hold the present invention when handling heavy pieces of firewood. Additionally, the grip protrusion 11 also provides additional weight to the present invention. The additional weight is beneficial for the pointed portion 3 to conveniently traverse into the piece of firewood.

When utilizing the present invention, the following process flow is followed. Initially, the user grips the present invention at the swinging grip portion 14. Next, the user swings the present invention such that the pointed portion 3 penetrates into the piece of firewood. In doing so, the tip 8 of the pointed portion 3 makes initial contact with the piece of firewood. The mass of the structural body 2 and the momentum of the swinging motion helps the pointed portion 3 establish a connection with the piece of firewood. In another embodiment of the present invention, when the head 1 comprises the gripping protrusion, the mass of the gripping protrusion 11 also helps the pointed portion 3 penetrate into the piece of firewood. Once the pointed portion 3 makes contact with the piece of firewood, the barb 10 prevents the present invention from losing contact with the piece of firewood. Upon establishing a secure connection between the present invention and the piece of firewood, the user can conveniently handle the piece of firewood. The position in which the user grasps the present invention depends on the size and weight of the piece of firewood. As an example, if the piece of firewood is lightweight, the user grasps the swinging grip portion 14 to handle the piece of firewood. On the other hand, if the piece of firewood is heavy, the user grasps the present invention at the lifting grip portion 15. If the lifting grip portion 15 is insufficient to handle the piece of firewood, the user grasps the structural body 2 due to the mechanical advantage obtained from the positioning of the structural body 2. When the gripping protrusion 11 is available in another embodiment of the present invention, the user can hold the present invention by both the structural body 2 and the gripping protrusion 11. When dragging, moving, or lifting the piece of firewood is complete, the user grasps the swinging grip portion 14 in order to remove the present invention from the piece of firewood. Multiple users can efficiently handle a large piece of firewood by utilizing the present invention at multiple locations simultaneously.

Although the invention has been explained in relation to its preferred embodiment, it is to be understood that many other possible modifications and variations can be made without departing from the spirit and scope of the invention as hereinafter claimed.

What is claimed is:

1. An apparatus for handling firewood comprises:
a head;
a handle;
the head comprises a structural body, a pointed portion, and a barb;
the handle being mounted adjacent to the structural body;
the pointed portion being connected adjacent to the structural body;
the pointed portion being oriented perpendicular to the structural body;
the barb being connected adjacent to the pointed portion, opposite to the structural body; and
the barb being oriented towards the handle.

2. The apparatus for handling firewood as claimed in claim 1 comprises:
the pointed portion comprises a top surface, a bottom surface, a first lateral surface, a second lateral surface, a tip, and a base;
the top surface being convexly configured with the pointed portion;
the bottom surface being concavely configured with the pointed portion;
the top surface and the bottom surface tapering the pointed portion from the base to the tip; and
the first lateral surface and the second lateral surface tapering the pointed portion from the base to the tip.

3. The apparatus for handling firewood as claimed in claim 1, wherein a line delineated between a tip of the pointed portion and a tip of the barb is oriented at an acute angle with a central axis of the handle.

4. The apparatus for handling firewood as claimed in claim 1 comprises:
the handle comprises a central axis, a swinging grip portion and a lifting grip portion;
the lifting grip portion being connected adjacent to the structural body; and
the swinging grip portion being connected adjacent to the lifting portion, opposite to the structural body.

5. The apparatus for handling firewood as claimed in claim 1 comprises:
a rubberized coating; and
the rubberized coating being superimposed onto the swinging grip portion.

6. The apparatus for handling firewood as claimed in claim 1 comprises:
the head further comprises a grip protrusion; and
the grip protrusion being connected adjacent the structural body, opposite to the pointed portion.

7. An apparatus for handling firewood comprises:
a head;
a handle;
the head comprises a structural body, a pointed portion, and a barb;
the pointed portion comprises a top surface, a bottom surface, a first lateral surface, a second lateral surface, a tip, and a base;
the handle being mounted adjacent to the structural body;
the pointed portion being connected adjacent to the structural body;
the pointed portion being oriented perpendicular to the structural body;
the barb being connected adjacent to the pointed portion, opposite to the structural body;
the barb being oriented towards the handle;
the top surface being convexly configured with the pointed portion;
the bottom surface being concavely configured with the pointed portion;
the top surface and the bottom surface tapering the pointed portion from the base to the tip; and
the first lateral surface and the second lateral surface tapering the pointed portion from the base to the tip.

8. The apparatus for handling firewood as claimed in claim 7, wherein a line delineated between a tip of the pointed portion and a tip of the barb is oriented at an acute angle with a central axis of the handle.

9. The apparatus for handling firewood as claimed in claim 7 comprises:
the handle comprises a central axis, a swinging grip portion and a lifting grip portion;
the lifting grip portion being connected adjacent to the structural body; and
the swinging grip portion being connected adjacent to the lifting portion, opposite to the structural body.

10. The apparatus for handling firewood as claimed in claim 7 comprises:
a rubberized coating; and
the rubberized coating being superimposed onto the swinging grip portion.

11. The apparatus for handling firewood as claimed in claim 7 comprises:
the head further comprises a grip protrusion; and
the grip protrusion being connected adjacent the structural body, opposite to the pointed portion.

12. An apparatus for handling firewood comprises:
a head;
a handle;
the head comprises a structural body, a pointed portion, and a barb;
the handle comprises a central axis, a swinging grip portion and a lifting grip portion;
the handle being mounted adjacent to the structural body;
the pointed portion being connected adjacent to the structural body;
the pointed portion being oriented perpendicular to the structural body;
the barb being connected adjacent to the pointed portion, opposite to the structural body;
the barb being oriented towards the handle;
the lifting grip portion being connected adjacent to the structural body; and
the swinging grip portion being connected adjacent to the lifting portion, opposite to the structural body.

13. The apparatus for handling firewood as claimed in claim 12 comprises:
the pointed portion comprises a top surface, a bottom surface, a first lateral surface, a second lateral surface, a tip, and a base;
the top surface being convexly configured with the pointed portion;
the bottom surface being concavely configured with the pointed portion;
the top surface and the bottom surface tapering the pointed portion from the base to the tip; and
the first lateral surface and the second lateral surface tapering the pointed portion from the base to the tip.

14. The apparatus for handling firewood as claimed in claim 12, wherein a line delineated between a tip of the pointed portion and a tip of the barb is oriented at an acute angle with a central axis of the handle.

15. The apparatus for handling firewood as claimed in claim 12 comprises:
a rubberized coating; and
the rubberized coating being superimposed onto the swinging grip portion.

16. The apparatus for handling firewood as claimed in claim 12 comprises:
the head further comprises a grip protrusion; and
the grip protrusion being connected adjacent the structural body, opposite to the pointed portion.
